(19) United States
(12) Patent Application Publication
(10) Pub. No.: US 2026/0243943 A1
(43) Pub. Date: Aug. 20, 2026

(54) LIGHTING DEVICE FOR VEHICLES

(71) Applicant: Hella GmbH & Co. KGaA, Lippstadt (DE)

(72) Inventors: Jacek Bernard, Lippstadt (DE); Julian Grote, Borchen (DE); Marc Kaup, Paderborn (DE); Martin Mügge, Geseke (DE)

(21) Appl. No.: 19/536,569

(22) Filed: Feb. 11, 2026

(30) Foreign Application Priority Data
Feb. 17, 2025 (DE) 102025105825.3

(51) Int. Cl. F21V 8/00

(52) U.S. Cl. CPC G02B 6/0051; G02B 6/0053; G02B 6/0068

(57) ABSTRACT

A lighting device for vehicles is provided. A transparent optical waveguide has a flat back side and a flat front side where light entering it undergoes total internal reflection in the direction in which the light is conducted. Light is emitted such that it exits the flat side of the waveguide in the main beam direction. A transparent optical film or plate diffuses light exiting the waveguide in the main beam direction. A cover plate is in front of the at least one optical film or plate. A lighting field matrix of lighting elements can be activated individually behind the optical waveguide in the main beam direction. When the lighting elements are switched on, a two-dimensional image of a lighting pattern or a second signal is generated by the waveguide in a lighting surface defined by the dimensions of the lighting field matrix.

### CROSS REFERENCE

This application claims priority to German Application No. 10 2025 105825.3, filed Feb. 17, 2025, the entirety of which is hereby incorporated by reference.

### FIELD OF THE INVENTION

The invention relates to a lighting device for vehicles that has a housing containing an optical waveguide with a flat back side and a flat front side where light entering the waveguide undergoes total internal reflection in the direction in which the light is conducted, and with a narrow side where the light enters the waveguide, a light source for generating the light that can enter the narrow side of the waveguide, means for emitting the light such that it exits the front side of the waveguide in the main beam direction, a transparent optical film or plate in front of the waveguide for diffusing the light exiting it, and a cover plate in front of the at least one optical film or plate where the light exits the housing.

### BACKGROUND OF THE INVENTION

DE 10 2012 004 759 A1 discloses a lighting device for vehicles that contains a lighting field matrix with numerous lighting elements arranged in a matrix, by means of which predefined lighting patterns, e.g. arrows or triangular warning signals, can be displayed. The lighting elements in the lighting field matrix that can be activated individually can be LEDs, OLEDs, or AMOLEDs. DE 10 2015 119 326 A1 also discloses a lighting device with a lighting field matrix. These lighting devices can be used to display additional information on a lighting surface.

DE 10 2015 119 326 A1 discloses a lighting device containing a lighting field matrix with which different signals can be generated.

The disadvantage with these lighting devices is that they require a relatively high number of lighting elements to generate the desired lighting functions or patterns.

A lighting device for vehicles that has a housing is disclosed in DE 10 2023 108 470 A1, in which there is a transparent optical waveguide that light enters at a narrow side. The light is propagated therein through total internal reflection on opposing parallel sides of the waveguide. There is at least one light source on the edge of the narrow side of the waveguide that generates the light. A reflector is placed at the back of the waveguide for light exiting there, where it is then reflected back into the waveguide such that it exits at the front in the main beam direction. There are transparent optical films or a transparent optical plate on the front for diffusing this light. A cover plate at the front closes off this light module. Consequently, a homogenously lit light emission surface is generated in this manner that can be used for signal light functions such as brake lights and tail lights.

### BRIEF SUMMARY OF THE INVENTION

The object of the present invention is to improve a lighting device for vehicles that contains an optical waveguide, such that the functionality of the lighting device can be easily improved in a space-saving manner.

This is achieved in that a lighting field matrix with numerous lighting elements that can be controlled individually is placed behind the optical waveguide, and that there are means for controlling the light sources and lighting elements with which a predefined signal light function can be generated with the waveguide when the light sources are switched on, and a two-dimensional lighting pattern or second signal light function can be generated by the waveguide when the lighting elements are switched on in a lighting surface defined by the dimensions of the lighting field matrix.

The particular advantage of the invention is that a signal light function, e.g. brake lights, tail lights, or daytime running lights, as well as a predefined lighting pattern, specifically a two-dimensional lighting pattern, can be generated over the entire lighting surface of a cover plate in a space-saving manner. This is achieved with a lighting field matrix that contains numerous lighting elements arranged in a matrix behind a transparent optical waveguide through which the light emitted by the activated lighting elements passes toward the cover plate. Because the light normally enters the waveguide at a narrow side thereof, e.g. when a row of LEDs are activated, the light emitted by the lighting field matrix can pass freely through the waveguide, where it is conducted in the main beam direction through optical films or an optical plate at the front thereof. Both the light from the lighting field matrix and that exiting the front of the waveguide are thus emitted over the same surface area of the cover plate. While the waveguide generates a homogenously lit signal function, the lighting field matrix generates an animated, pixelated image containing symbols, indicators, and warnings, e.g. “welcome and goodbye displays” in a part of the cover plate covering the waveguide.

There can also be a reflector at the back of the optical waveguide that has a reflective surface with which the light exiting the waveguide at the back is reflected back into the waveguide. The reflector has a cutout that is large enough for the light emitted by the lighting field matrix to pass through it into the back of the waveguide and then exit the front thereof. Because the waveguide is transparent, it does not interfere with the lighting pattern display. This requires that the lighting field matrix is smaller than the waveguide. The two-dimensional lighting pattern generated by the lighting field matrix thus forms part of the lighting surface of the waveguide. If the cutout is smaller than the side of the waveguide, the lighting pattern generated by the lighting field matrix can be encompassed in a light frame generated by the waveguide. This can be used to reinforce the effects of the signals or information generated by the lighting field matrix through appropriate control of the light sources for the waveguide.

The lighting field matrix can also contain a printed circuit board with numerous lighting elements arranged in a matrix thereon. These lighting elements are preferably LEDs. The printed circuit board has a reflective coating, at least on the side facing the waveguide, thus assuming the role of the reflector. Because the surface area occupied by all of the lighting elements is relatively small in comparison to the entire surface area of the printed circuit board, it can provide a uniform, homogenous reflection of the light exiting the back of the waveguide. Consequently, the printed circuit board can basically compensate for the reflection lost by the cutout in the reflector. Because there is at least one optical film or an optical plate with diffusors at the front of the waveguide, a homogenous light emission from the cover plate can be obtained by simply controlling the light sources for the waveguide, without any apparent difference between the different surface areas of the cover plate where the reflective surface and the printed circuit board are located behind the waveguide.

The thickness of the reflector can be equal to or greater than the height of the lighting elements on the printed circuit board. The reflector thus forms a spacer preventing the lighting elements from coming in contact with the back of the waveguide. The lighting elements are preferably relatively flat LEDs.

The printed circuit board, reflector, optical waveguide, and optical films or plate can bear directly on one another. This results in a relatively flat structure for the lighting device, that can be easily adapted to the shape of the front or back end of the vehicle.

Micro-optical elements can also be placed on the back side of the optical waveguide as means for directing the light out of the waveguide. These redirect the light therein toward the front, where it can then exit the waveguide. Any light exiting the back of the waveguide is still reflected back into it by the reflector or the printed circuit board, such that it is not lost and can still contribute to generating the signal function.

The concentration of the micro-optical elements in an area at the back side of the optical waveguide covered by the cutout in the reflective film is lower than in the area covered by the reflective film. This improves the appearance of the light pattern generated by the lighting field matrix. This is achieved by a reduced diffusion in the display portion of the lighting field generated by the lighting field matrix.

Both the lighting elements in the lighting field matrix and the light sources for the waveguide can be switched on to increase the size of the overall effective lighting surface beyond that obtained when only the lighting elements in the lighting field matrix are switched on. To improve the appearance of the lighting pattern, the light sources for the optical waveguide directed through the part of the waveguide covered by cutout in the reflecting surface are dimmed in comparison with the light from the light sources directed toward a part of the waveguide not covered by the cutout. Consequently, the contrast can be altered, making it easier to discern the content of the lighting pattern.

The housing can comprise a front part and back part, in which case the front part forms a frame. The lighting field matrix, reflector, optical waveguide, and at least one optical film or plate are contained between these two parts of the housing. This can form a panel for the front or back of the vehicle that spans the entire width thereof. This results in a lighting surface with numerous lighting functions and patterns extending from one side of the vehicle to the other. By way of example, a continuous lighting strip can be formed at the front or back of the vehicle, which is placed in a single opening formed in the body of the vehicle.

The back part of the housing can contain numerous receivers for the lighting field matrix and headlight modules. The headlight modules are placed between optical waveguides, such that numerous waveguides of the same size can be used. This results in a simple and symmetrical structure for the lighting device.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a perspective view of an example embodiment of a lighting device from the front.

FIG. 2 shows a perspective view of an example embodiment of a lighting device from the back.

FIG. 3 shows an exploded view of an example embodiment of a lighting device from the side.

FIG. 4 shows a partially cutaway exploded view of an example embodiment of a lighting device from the front.

FIG. 5 shows part of an example embodiment of a lighting device from the front, in which the optical waveguide is exposed.

FIG. 6 shows various layers of an example embodiment of a lighting device.

### DETAILED DESCRIPTION OF THE DRAWINGS

A lighting device 1 for vehicles is obtained with the invention that can be placed in an opening in the body of the vehicle at the front or back to generate numerous lighting functions and a two-dimensional lighting pattern display.

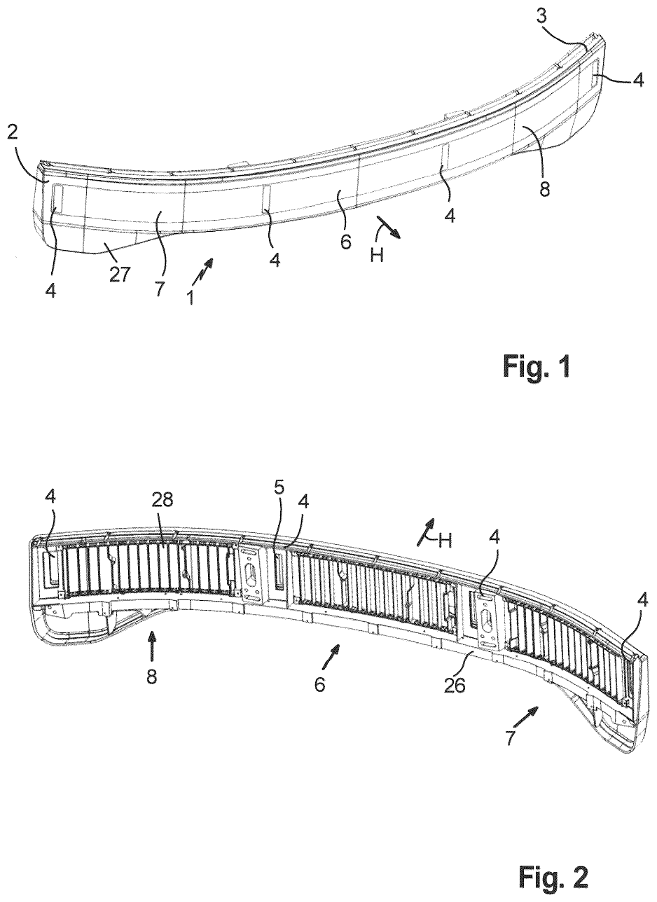

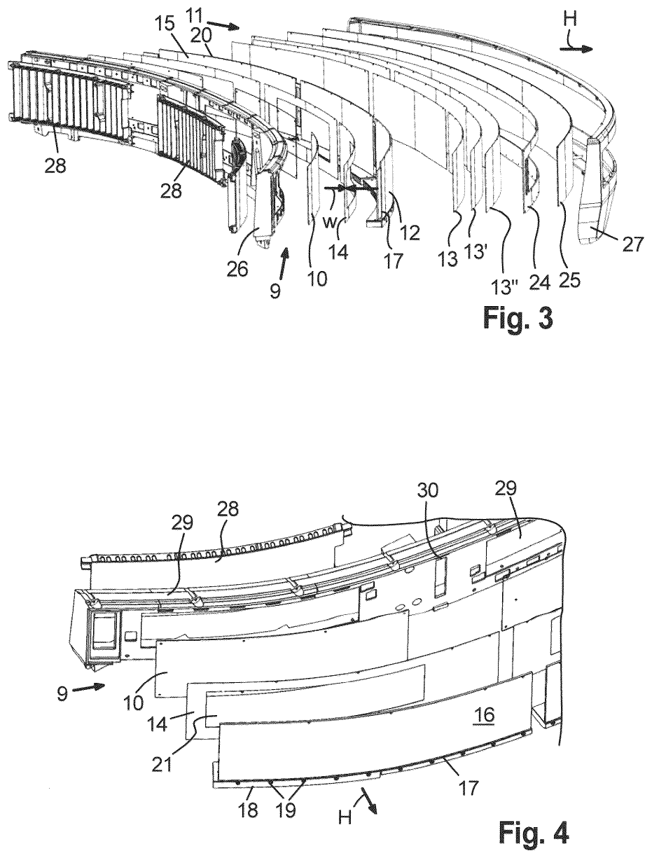

As shown in FIGS. 1 and 2, the lighting device can be elongated, with a first end 2 and second end 3. The lighting device 1 preferably extends over the entire width of the vehicle, such that the first end 2 is near a first side of the vehicle and the second end 3 is near the other side of the vehicle. The distance between the two sides of the vehicle corresponds to the width of the vehicle.

The lighting device 1 in the present exemplary embodiment forms a structural unit containing numerous lighting modules.

The lighting device 1 can be placed in the front of the vehicle, and can contain four main lighting modules 4 for generating low beams and high beams. These main lighting modules 4 are distributed over the length of the lighting device 1, e.g. at a uniform distance to one another. The two outer main lighting modules 4 are at the first end 2 and second end 3 of the lighting device 1. The two inner main lighting modules 4 are in the middle of the lighting device 1. The main lighting modules 4 contain light sources (not shown), preferably LEDs, and optical elements, preferably at least one lens 5.

The lighting device also contains a large lighting module 6 in the middle, a large lighting module 7 on the right, and a large lighting module 8 on the left. The lighting module 7 on the right and the lighting module 8 on the left can be used for generating turn signals and/or daytime running lights. The middle lighting module 6 can be used to generate a position light and/or daytime running light.

The lighting modules 6, 7, 8 are relatively large, specifically at least ten times are large as the main lighting modules 4.

The main lighting modules 4 are all the same size, as are the larger lighting modules 6, 7, 8, thus keeping production costs low.

What makes the larger lighting modules 6, 7, 8 special is that they can be used not only to generate signals, but also to generate two-dimensional lighting patterns, e.g. symbols or information, e.g. warnings, arrows, or animated “welcome” or “goodbye” messages. Consequently, an animated, pixelated image can be created.

There is a lighting field matrix 9 for creating these two-dimensional images, which contains a printed circuit board 10 and numerous lighting elements, preferably LEDs, arranged in a matrix thereon. These LEDs are formed by LED chips, which are relatively flat and small (mini-LEDs), and are arranged in a uniform matrix structure on the printed circuit board 10, preferably in uniform rows and columns. Each of the larger lighting modules 6, 7, 8 has such a lighting field matrix 9.

Because the printed circuit board 10 is flexible, the lighting field matrices 9 can be curved and the lighting device 1 can be curved or bowed slightly from the first end 2 to the second end 3.

An optical waveguide unit 11 is placed in front of the lighting field matrices 9 in the main beam direction H for the lighting device 1, which substantially contains an optical waveguide 12, at least one optical film 13, 13′, 13″ in front of the waveguide 12, and a reflector 14 behind the waveguide 12.

The lighting field matrix 9 forms a display for the two-dimensional lighting pattern formed by activating the individual lighting elements.

The optical waveguide 12 is transparent and has a back side 15 and front side 16 at which the light entering it undergoes total internal reflection in the direction in which the light is conducted. The lower narrow side 17 of the waveguide 12 in this exemplary embodiment is where the light from numerous light sources 19 on a printed circuit board 18 following the course of this narrow side 17 enters the waveguide 12. The light sources 19 are LEDs. The light is then conducted through total internal reflection on the preferably parallel front side 16 and back side 15 from the narrow side 17 where the light enters to the opposing upper narrow side 20.

To allow the light to exit at the front side 16 in the main beam direction H, micro-optical elements can be formed on the back side 15. When a first portion of the light strikes these micro-optical elements, it is reflected back, such that it strikes the front side 16 of the waveguide 12 at a steep angle, and can exit the waveguide 12 at the front side 16 through refraction. Another portion of the light, which exits the back side 15 of the waveguide 12 is reflected back into the waveguide 12 by the reflector 14, such that this portion can exit the waveguide 12 at the front side 16. The reflector 14 therefore contributes to the amount of light exiting the waveguide 12 at the front side 16.

In another embodiment of the invention, there are no micro-optical elements on the waveguide 12, increasing the amount of light exiting the back side 15. This light can nevertheless still be used for signal functions through reflection on the reflector 14.

In order to reflect the light exiting the back of the waveguide 12, the reflector 14 has a mirroring or white reflective surface that reflects the light exiting it back into the waveguide.

To make the lighting surface formed by the lighting field matrix 9 visible from the outside, the reflector 14 has a cutout 21 that corresponds to the size of the lighting surface or the lighting field matrix 9. The size of the cutout 21 in the reflector 14 preferably corresponds to the size of the lighting field matrix 9, such that the lighting surface formed by the lighting field matrix 9 is visible from the outside through the transparent waveguide 12 and the transparent optical films 13, 13′, 13″.

To obtain a homogenous lighting surface when the waveguide unit 11 is in use, the printed circuit board 10 for the lighting field matrix 9 has a reflective coating, preferably a white solder mask.

Alternatively, the printed circuit board 10 can have a silver solder mask on the side facing the waveguide, or it can have a color corresponding to the color of the reflective surface of the reflector 14.

To ensure the lighting pattern is recognizable when the display unit is in use, the printed circuit board 10, lighting field matrix 9 and the flat components of the waveguide unit 11 are placed directly next to one another, or at a minimum distance to one another. The reflector 14 has a sufficient thickness w to prevent the lighting elements in the lighting field matrix 9 from coming in contact with the back side 15 of the optical waveguide 12, which is at least the same as the height of the lighting elements. This prevents the lighting elements from coming in contact with the waveguide 12. The reflector 14 thus forms a spacer for the lighting elements in the lighting field matrix 9. The reflector 14 is preferably a reflective film with a thickness w of 0.2 mm to 0.5 mm, preferably 0.3 mm.

The reflective film is preferably colored, specifically white or silver, or some other reflective color.

The concentration of the micro-optical elements in an area at the back side 15 of the optical waveguide 12 covered by the cutout 21 in the reflective film 14 is preferably lower than in the area covered by the reflective film 14. This makes it easier to recognize the lighting pattern shown by the lighting field matrix 9.

The transparent optical films 13, 13′, 13″ preferably have diffusion elements on the front side, facing away from the optical waveguide 12, for diffusing the light exiting the waveguide 12, thus ensuring that the lit surface has a harmonious appearance.

There can also be just one or two optical films. Alternatively, an optical plate, with or without diffusing elements, can be used.

The diffusing elements should not diffuse light to the extent that the lighting pattern in the lighting field matrix 9 becomes unclear. The at least one optical film 13, 13′, 13″ with the diffusing elements must therefore be adjusted to the application, i.e. the type of lighting pattern.

These diffusing elements on the at least one optical film 13, 13′, 13″ conceal the LEDs in the lighting field matrix 9 when they are switched off. They first become visible as points of light or pixels when the lighting elements in the lighting field matrix 9 are switched on. The points of light or pixels are expanded by the micro-optics on the waveguide 12 and the diffusing elements on the optical films 13, 13′, 13″. The resulting loss in contrast is irrelevant, because the symbols remain recognizable.

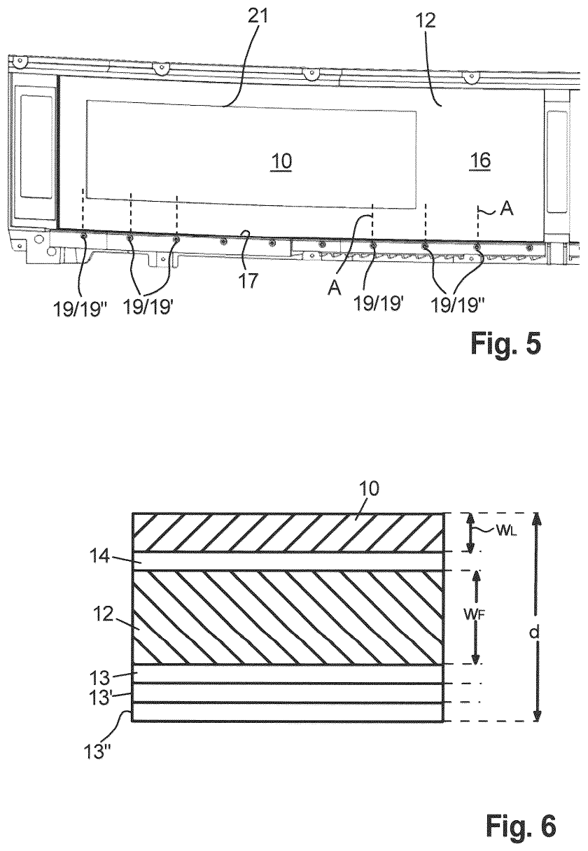

There is a control unit, not shown, for either the lighting elements in the lighting field matrix 9, or the light sources 19 for the waveguide unit 11. The control unit could also be configured for both the lighting elements in the lighting field matrix 9 and the light sources 19 for the waveguide unit 11. This generates a lighting pattern in a light frame, and/or covered by a light grid, because the surface area of the optical waveguide 12 is greater than the size of the lighting field matrix 9, see FIG. 5. To improve the appearance of the lighting pattern, in particular the information or content of the lighting field matrix 9, a first portion 19′ of the light sources 19 for the waveguide unit 11, the main axes A of which intersect with a part of the waveguide 12 covered by the cutout 21, are dimmed in comparison with a second portion 19′ of the light sources 19, the main axes A of which do not intersect with the part of the waveguide 12 covered by the cutout 21.

The lighting field matrix 9 can be an LED matrix display, mini-or micro-LED matrix display, OELD display, AMOLD display, or a segment display (CMX: communication matrix).

The display can be monochrome, i.e. white when used in the front end of the vehicle, or red when used in the back end. The lighting elements can emit white or red light. There is no change in color, because the optical waveguide 12 and the at least one optical film 13, 13′, 13″ are transparent. The lighting elements in the lighting field matrix 9 could also be RGB lighting elements, allowing for different colors to be generated in the lighting surface of the lighting field matrix 9. The color of the lighting elements therefore determines the color of the lighting field matrix 9 or a part thereof. The preferably numerous lighting field matrices 9 at the front and/or the back of the vehicle can therefore generate numerous lighting surfaces of the same or different colors.

The lighting device 1 preferably has a cover 24 in front of the optical films 13, 13′, 13″, and a transparent cover plate 25. The cover 24 forms a frame with an opening exposing the lighting modules 4, 6, 7, 8.

The aforementioned flat components, specifically the printed circuit board 10, lighting field matrix 9, reflective film 14, optical waveguide 12, optical films 13, 13′, 13″, cover frame 24, and cover plate 25 are contained between a back housing part 26 and a front housing part 27, the front of which forms a frame with an opening that exposes the lighting modules 4, 6, 7, 8. The transparent cover plate 25 is in the opening in the housing. Numerous heat sinks 28 can be attached to the back housing part 26, which also forms a frame, for cooling the lighting elements in the lighting field matrix 9. Both the front part 27 and back part 28 of the housing are made of an opaque material.

The back housing part 26 has first receivers 29 for the three identical lighting field matrices 9, and second receivers 30 for the four main lighting modules 4 (headlight modules).

The lighting device 1 could also have just one lighting module composed of just the lighting field matrix 9 and the waveguide unit 11 in front of it.

The lighting device 1 can be placed in an opening in the back end of the vehicle, such that instead of headlights, it can form tail lights and brake lights with the waveguide unit 11. In this case, the smaller main lighting modules 4 are omitted entirely. When used for the back, there can be numerous lighting modules of the same size, each of which is composed of a lighting field matrix 9 with a waveguide unit 11 in front of it.

The printed circuit board 10 for the lighting field matrix 9, the reflective film 14, the optical waveguide 12, and the optical films 13, 13′, 13″ form a structural unit with a thickness d of 5 mm to 6 mm. The printed circuit board 10 has a thickness w_{L} of 1 mm to 1.5 mm, the reflective film 14 and two optical films each have a thickness w of 0.3 mm, and the optical waveguide 12 has a thickness w_{F} of 3 mm. This results in an overall thickness d of 5.7 mm.

The structural unit can be flat or curved about an axis perpendicular to the main beam direction H, which is preferably vertical, or it can be curved cylindrically.

Taking the heat sinks 28 and the housing 26, 27 into account, the thickness is 20 mm to 25 mm. The lighting device 1 can be adapted to the shape of the front or back of the vehicle.

The lighting field matrix 9 or the lighting elements thereof can be controlled such that a second lighting signal is generated by the optical waveguide 12 in a lighting surface defined by the size of the lighting field matrix 9.

### LIST OF REFERENCE SYMBOLS

1 lighting device
2 1^{st} end
3 2^{nd} end
4 main lighting module
5 lens
6 middle lighting module
7 right-hand lighting module
8 left-hand lighting module
9 lighting field matrix
10 printed circuit board
11 optical waveguide unit
12 optical waveguide
13, 13′, 13″ optical films
14 reflector/reflective film
15 back side
16 front side
17 narrow side
18 printed circuit board
19 light sources
19′ 1^{st} portion
19″ 2^{nd} portion
20 upper narrow side
21 cutout
24 cover
25 cover plate
26 back housing part
27 front housing part
28 heat sink
29 1^{st} receiver
30 2^{nd} receiver
H main beam direction
w, w_{L}, w_{F} thicknesses
A main axis
d thickness

1. A lighting device for vehicles, the lighting device comprising:
a housing;
a transparent optical waveguide with a narrow side where light enters the waveguide, and with a flat back side and a flat front side, wherein light entering the transparent optical waveguide undergoes total internal reflection in a direction in which the light is conducted;
a light source for generating the light that enters the narrow side of the waveguide;
means for emitting the light such that it exits the flat side of the waveguide in a main beam direction (H);
a transparent optical film or plate for diffusing the light exiting the waveguide in the main beam direction (H);
a cover plate in front of the at least one optical film or plate where the light exits the housing;
a lighting field matrix of lighting elements that selectively individually activatable behind the optical waveguide in the main beam direction (H); and
a mechanism for controlling the light source and lighting elements, such that when the light source is switched on, a predefined signal is generated by the waveguide, and when the lighting elements are switched on, a two-dimensional image of a lighting pattern or a second signal is generated by the waveguide in a lighting surface defined by the dimensions of the lighting field matrix.

2. The lighting device according to claim 1, wherein a reflector bears on the back side of the optical waveguide, which has a reflecting surface that reflects light exiting the waveguide back into the back side of the waveguide, and
wherein the reflector has a cutout that is large enough for light emitted from the lighting field matrix to pass through it into the waveguide.

3. The lighting device according to claim 1, wherein the lighting field matrix contains a printed circuit board and numerous lighting elements, wherein the printed circuit board is coated with a reflective material.

4. The lighting device according to claim 3, wherein the reflective coating on the printed circuit board is formed by a white or silver solder mask, or is the same color as the reflective surface on the reflector.

5. The lighting device according to claim 1, wherein the reflector has a thickness (w) equal to or greater than the height of the lighting element.

6. The lighting device according to claim 1, wherein the reflector is a colored film with a width of 0.2 mm to 0.5 mm.

7. The lighting device according to claim 3, wherein the printed circuit board in the lighting field matrix, the reflector, the optical waveguide, and the at least one optical film or plate bear directly on one another.

8. The lighting device according to claim 3, wherein the printed circuit board in the lighting field matrix has a thickness of 1 mm to 1.5 mm, the reflective film and two optical films each have a thickness of 0.3 mm, and the optical waveguide has a thickness of 3 mm.

9. The lighting device according to claim 3, wherein a structural unit formed by the printed circuit board, reflective film, optical waveguide and the at least two optical films has a thickness of 5 mm to 6 mm, and wherein the structural unit is flat or curved.

10. The lighting device according to claim 2, wherein micro-optical elements are formed on the back side of the optical waveguide as mechanisms for emitting light therefrom.

11. The lighting device according to claim 10, wherein a concentration of the micro-optical elements in an area at the back side of the optical waveguide covered by the cutout in the reflective film is lower than in the area covered by the reflective film.

12. The lighting device according to claim 2, wherein the at least one optical film contains diffusing elements on the front surface, facing away from the optical waveguide.

13. The lighting device according to claim 11, wherein there are numerous rows of light sources on the narrow side of the optical waveguide, and
wherein a control unit is configured to generate the lighting pattern when the lighting elements are switched on, such that light sources for the optical waveguide, main axes (A) of which intersect the part of the waveguide covered by the cutout, are operated with less current that the other light sources, the main axes (A) of which do not intersect the part of the waveguide covered by the cutout.

14. The lighting device according to claim 3, wherein there is a housing with a back part and a front part, wherein at least the front part forms a frame with an opening, and wherein the lighting field matrix, reflective film, optical waveguide and at least one optical film or plate are contained between the front part and the back part.

15. The lighting device according to claim 14, wherein the back part of the housing has numerous receivers (29, 30), the first of which is for the lighting field matrix and the second of which is for a headlight module.

16. The lighting device according to claim 3, wherein the lighting elements in the lighting field matrix or numerous lighting field matrices are designed such that the same or different colors are generated on the lighting surface of the lighting field matrix or the lighting surfaces of numerous lighting field matrices.

17. The lighting device according to claim 6, wherein the reflector is white or silver or another reflective color.
